(19) United States
(12) Patent Application Publication
(10) Pub. No.: US 2017/0266846 A1
(43) Pub. Date: Sep. 21, 2017

(54) METHOD AND DEVICE OF MANUFACTURING FIBER-REINFORCED RESIN MATERIAL

(71) Applicant: TOYOTA JIDOSHA KABUSHIKI KAISHA, Toyota-shi (JP)

(72) Inventor: Tetsuya ODA, Toyota-shi (JP)

(73) Assignee: TOYOTA JIDOSHA KABUSHIKI KAISHA, Toyota-shi (JP)

(21) Appl. No.: 15/458,434

(22) Filed: Mar. 14, 2017

(30) Foreign Application Priority Data
Mar. 18, 2016 (JP) 2016-054726

(51) Int. Cl. B29B 7/46; B29B 7/82; B29B 7/90; B29B 15/10

(52) U.S. Cl. CPC B29B 7/46; B29B 15/105; B29B 7/82; B29B 7/90; B29K 2301/12

(57) ABSTRACT

A method of manufacturing a fiber-reinforced resin material, includes preparing a kneaded material by melting a thermoplastic resin and kneading the molten thermoplastic resin with reinforcing fibers; preparing a reinforcing fiber-impregnated material including a supercritical fluid by accommodating the kneaded material in a sealed space and supplying the supercritical fluid into the sealed space such that the molten thermoplastic resin is impregnated into the reinforcing fibers included in the kneaded material; and manufacturing the fiber-reinforced resin material by extracting the reinforcing fiber-impregnated material from the sealed space and leaving the reinforcing fiber-impregnated material to stand in a reduced-pressure atmosphere such that the supercritical fluid foams.

### INCORPORATION BY REFERENCE

The disclosure of Japanese Patent Application No. 2016-054726 filed on Mar. 18, 2016 including the specification, drawings and abstract is incorporated herein by reference in its entirety.

### BACKGROUND

1. Technical Field

The present disclosure relates to a method and a device of manufacturing a fiber-reinforced resin material.

2. Description of Related Art

A fiber-reinforced resin material (fiber-reinforced plastic (FRP)) obtained by incorporating reinforcing fibers into a thermoplastic resin has light weight, high strength, and high stiffness and thus is used in various industrial fields, for example, the automobile industry, the construction industry, or the aviation industry.

For example, in the automobile industry, the fiber-reinforced resin material is applied to a frame structural member of a vehicle such as a pillar or a rocker and a body panel member such as a underfloor panel or a door outer panel, thereby realizing a reduction in the weight of the vehicle and low fuel consumption.

Regarding reinforcing fibers such as carbon fibers or glass fibers, mainly, continuous fibers having a length of 50 mm or more are applied to the frame structural member. In addition, long fibers having a fiber diameter of less than 50 mm or short fibers having a shorter diameter than long fibers are applied to the body panel member.

As a method of manufacturing a fiber-reinforced resin material of the related art, a method is used which includes: supplying reinforcing fibers to molten thermoplastic resin; stirring and kneading the components along with rotations of two screws of a twin screw extruder; and extruding the kneaded material into a fiber-reinforced resin material.

Japanese Patent Application Publication No. 2015-039879 (JP 2015-039879 A) discloses a method of manufacturing a fiber-reinforced resin material in which a thermoplastic resin and reinforcing fibers are kneaded and extruded.

### SUMMARY

In this method of manufacturing a fiber-reinforced resin material, in order to improve properties of the fiber-reinforced resin material, an attempt to increase the fiber diameter of the reinforcing fibers by reducing the rotating speed of the screws of the twin screw extruder or by adopting a screw which is designed to have a low stirring force may be considered.

However, for example, in a case where the rotating speed of the screws is reduced to increase the fiber diameter of the reinforcing fibers, energy applied to the reinforcing fibers is reduced, and insufficient dispersion of the reinforcing fibers (aggregation of the reinforcing fibers) may occur. Due to the insufficient dispersion of the reinforcing fibers, the area of interfaces between the thermoplastic resin and the reinforcing fibers is reduced, which may lead to deterioration in the mechanical properties of the manufactured fiber-reinforced resin material.

On the other hand, in order to improve the dispersion of the reinforcing fibers, the rotating speed of the screws of the twin screw extruder may be increased or a screw which is designed to have a high stirring force may be adopted to increase the energy applied to the reinforcing fibers. In this case, the fiber diameter of the reinforcing fibers is reduced. As a result, the strength utilization of the reinforcing fibers is reduced, which may also lead to deterioration in the mechanical properties of the manufactured fiber-reinforced resin material.

Therefore, the development of a method and a device of manufacturing a fiber-reinforced resin material has been earnestly desired in the related art, in which, in a case where reinforcing fibers are mixed with a thermoplastic resin to manufacture a fiber-reinforced resin material, a fiber-reinforced resin material having excellent mechanical properties can be manufactured by uniformly dispersing the reinforcing fibers in the thermoplastic resin while maintaining the fiber diameter of the reinforcing fibers.

The disclosure provides a method and a device of manufacturing a fiber-reinforced resin material, in which reinforcing fibers can be uniformly dispersed in a thermoplastic resin while maintaining the fiber diameter of the reinforcing fibers and in which a fiber-reinforced resin material having excellent mechanical properties can be manufactured.

According to a first aspect of the disclosure there is provided a method of manufacturing a fiber-reinforced resin material, the method including: preparing a kneaded material by melting a thermoplastic resin and kneading the molten thermoplastic resin with reinforcing fibers; preparing a reinforcing fiber-impregnated material including a supercritical fluid by accommodating the kneaded material in a sealed space and supplying the supercritical fluid into the sealed space such that the molten thermoplastic resin is impregnated into the reinforcing fibers included in the kneaded material; and manufacturing the fiber-reinforced resin material by extracting the reinforcing fiber-impregnated material from the sealed space and leaving the reinforcing fiber-impregnated material to stand in a reduced-pressure atmosphere such that the supercritical fluid foams.

The supercritical fluid refers to a fluid having diffusibility which is a gas property and meltability which is a liquid property. Examples of the supercritical fluid include nitrogen (critical temperature Tc=−147° C., critical pressure Pc=3.4 MPa) and carbon dioxide (critical temperature Tc=about 31° C., critical pressure Pc=about 7.4 MPa).

By supplying the supercritical fluid having diffusibility as a gas property and meltability as a liquid property to the molten thermoplastic resin, the thermoplastic resin can be easily impregnated into a bundle of several thousands to several ten thousands of reinforcing fibers.

By causing the supercritical fluid to be present between respective molecular chains of the molten resin, an effect of reducing friction between the molecular chains of the thermoplastic resin to reduce the melt viscosity of the thermoplastic resin in an extruder which extrudes the reinforcing fiber-impregnated material can be expected, which promotes the impregnation of the thermoplastic resin into the bundle of the reinforcing fibers.

By extracting the reinforcing fiber-impregnated material including the supercritical fluid from the sealed space and leaving the reinforcing fiber-impregnated material to stand in a reduced-pressure atmosphere, the supercritical fluid foams (is gasified), and the reinforcing fibers are disintegrated from a bundle and can be dispersed in the thermoplastic resin. “Reduced-pressure atmosphere” refers to an atmosphere in which the pressure is reduced to be lower than the high internal pressure of the sealed space. For example, an atmospheric pressure atmosphere is included in “reduced-pressure atmosphere”.

In this way, the supercritical fluid is supplied to the sealed space in which the kneaded material is accommodated. Further, the reinforcing fiber-impregnated material including the supercritical fluid, which is prepared in the sealed space, is extracted from the sealed space and is left to stand in a reduced-pressure atmosphere. As a result, the thermoplastic resin is impregnated into the bundle of reinforcing fibers, and the reinforcing fibers are dispersed in the thermoplastic resin. Therefore, the area of interfaces between the thermoplastic resin and the reinforcing fibers increases, and a fiber-reinforced resin material having excellent mechanical properties can be manufactured.

Here, as the thermoplastic resin to be used, various thermoplastic resins can be used irrespective of whether to be crystalline or amorphous. Representative examples of the thermoplastic resin include polyethylene (PE), polypropylene (PP), and nylon (for example, PA: nylon 6 or nylon 66).

Examples of the reinforcing fibers used include ceramic fibers, inorganic fibers such as glass fibers or carbon fiber, metal fibers, and organic fibers. Among these reinforcing fibers, one kind may be used alone, or a mixed material of two or more kinds may be used.

When the fiber-reinforced resin material is manufactured, the fiber-reinforced resin material may be manufactured by cutting the reinforcing fibers while the supercritical fluid foams.

When the fiber-reinforced resin material is manufactured, by cutting the reinforcing fibers using a cutter such as a kneading screw having a high shearing force (or a high stirring force), the shearing force is applied in a state where the thermoplastic resin is sufficiently impregnated into the reinforcing fibers. The shearing force transmitted from the thermoplastic resin to the reinforcing fibers is as uniform as possible in the entire region, and a variation in the fiber diameter of the reinforcing fibers can be reduced or eliminated. Here, various methods can be considered as a method of cutting the reinforcing fibers. Examples of the methods include a mechanical cutting method using a kneading screw, a cutting method of adding an acid to the reinforcing fibers to damage the reinforcing fibers, and a cutting method of transmitting a rotating force of a screw to the reinforcing fibers through the resin.

According to a second aspect of the disclosure, there is provided a device of manufacturing a fiber-reinforced resin material, the device including: a melting portion that melts a thermoplastic resin; a kneading portion that supplies reinforcing fibers to molten thermoplastic resin and kneads the reinforcing fibers and the molten thermoplastic resin with each other; a supercritical fluid supplying portion having a sealed space in which a supercritical fluid is supplied to a kneaded material including the thermoplastic resin and the reinforcing fibers; and a pressure-reduced portion in which a reinforcing fiber-impregnated material including the kneaded material and the supercritical fluid is left to stand in a reduced-pressure atmosphere.

The melting portion is formed of, for example, a twin screw extruder. For example, the thermoplastic resin having a pellet shape is supplied to the twin screw extruder which forms the melting portion, and the thermoplastic resin is melted and supplied to the kneading portion while being rotated by the full flight screws.

The kneading portion is also formed of, for example, another twin screw extruder. In the kneading portion, the reinforcing fibers are supplied to the molten thermoplastic resin which is supplied from the melting portion, and a kneaded material including the thermoplastic resin and the reinforcing fibers is prepared while being rotated by full flight screws.

For example, the sealed space is provided at intermediate positions of the twin screw extruder which forms the kneading portion, and the supercritical fluid is supplied to the kneaded material supplied to the sealed space.

Here, “sealed space” refers to a space which is literally closed by sealing. In order to maintain the supercritical state of the supercritical fluid, the sealed space is formed such that the internal pressure of the space is maintained to be high.

As a sealing mechanism of the sealed space, an appropriate mechanism which stops the flows of the materials in the twin screw extruder to increase the material filling rate in the sealed space is applied, and examples thereof include a seal ring, a reverse kneading disk screw, a reverse full flight screw, and a gate valve.

By supplying the supercritical fluid into the sealed space, the supercritical fluid can be sufficiently diffused and impregnated into the thermoplastic resin, and the foaming or volatilization of the supercritical fluid caused by a reduction in the internal pressure of the twin screw extruder can be prevented before the supercritical fluid is impregnated into the bundle of the reinforcing fibers together with the thermoplastic resin.

The pressure-reduced portion is provided downstream of the sealed space, in which the reinforcing fiber-impregnated material including the kneaded material and the supercritical fluid is left to stand in a reduced-pressure atmosphere.

The pressure-reduced portion is a region which is provided outside the high-pressure sealed space and where the high-pressure state is naturally converted into a reduced-pressure state. In the pressure-reduced portion, it is not necessary that the pressure is actively reduced using any pressure reducing means (the pressure-reduced portion may be a region of an atmospheric pressure atmosphere).

By extracting the reinforcing fiber-impregnated material including the supercritical fluid from the sealed space to the pressure-reduced portion and leaving the reinforcing fiber-impregnated material to stand in a reduced-pressure atmosphere, the supercritical fluid foams (is gasified), and the reinforcing fibers are disintegrated from a bundle and can be dispersed in the thermoplastic resin.

In the pressure-reduced portion, for example, a kneading screw having a high shearing force (or a high stirring force) may be provided.

As can be seen from the above description, according to the method and the device of manufacturing a fiber-reinforced resin material according to the disclosure, the kneaded material including the molten thermoplastic resin and the reinforcing fibers is accommodated in the sealed space, and the supercritical fluid is supplied into the sealed space. In addition the reinforcing fiber-impregnated material including the supercritical fluid is extracted from the sealed space and is left to stand in a reduced-pressure atmosphere such that the supercritical fluid foams. As a result, the thermoplastic resin is impregnated into the bundle of reinforcing fibers, and the reinforcing fibers are dispersed in the thermoplastic resin. Therefore, the area of interfaces between the thermoplastic resin and the reinforcing fibers increases, and a fiber-reinforced resin material having excellent mechanical properties can be manufactured.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a flowchart showing a method of manufacturing a fiber-reinforced resin material according to a first embodiment of the disclosure;

FIG. 2 is a diagram schematically showing a device of manufacturing a fiber-reinforced resin material according to the first embodiment of the disclosure;

FIG. 3 is an enlarged view schematically showing a sealed space;

FIG. 4 is a flowchart showing a method of manufacturing a fiber-reinforced resin material according to a second embodiment of the disclosure;

FIG. 5 is a diagram schematically showing a device of manufacturing a fiber-reinforced resin material according to the second embodiment of the disclosure;

FIG. 6A is an image showing the external appearance of a fiber-reinforced resin material according to Comparative Example; and

FIG. 6B is an image showing the external appearance of a fiber-reinforced resin material according to Example.

### DETAILED DESCRIPTION OF EMBODIMENTS

Hereinafter, methods and devices of manufacturing a fiber-reinforced resin material according to first and second embodiments of the disclosure will be described with reference to the drawings.

(First Embodiment of Method and Device of Manufacturing Fiber-Reinforced Resin Material)

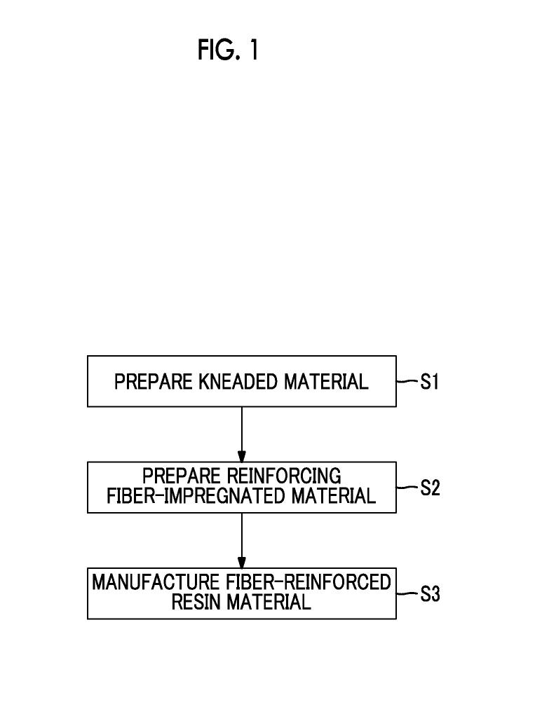

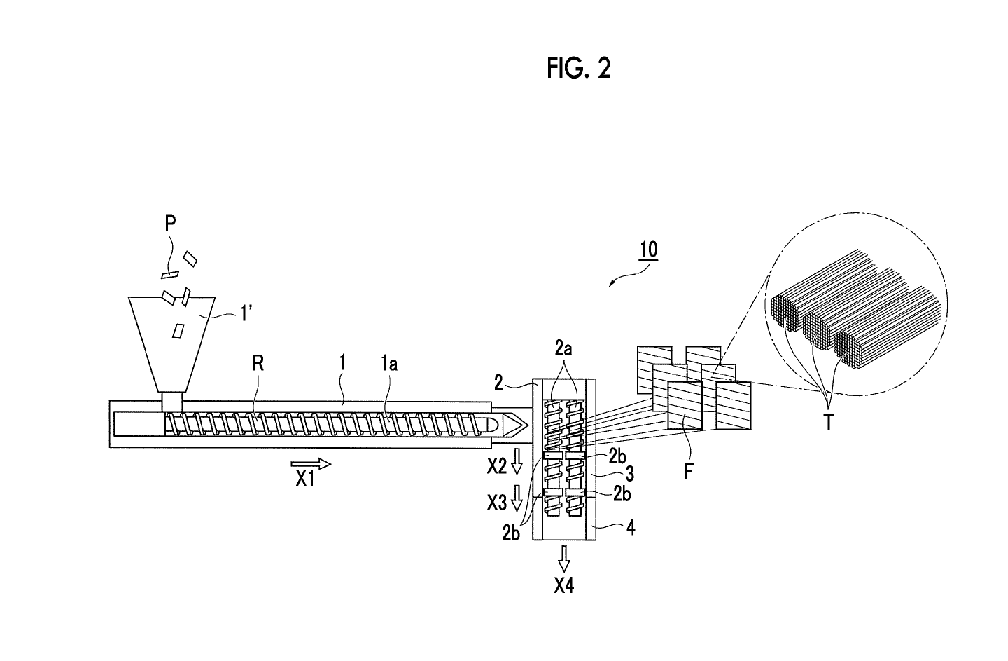

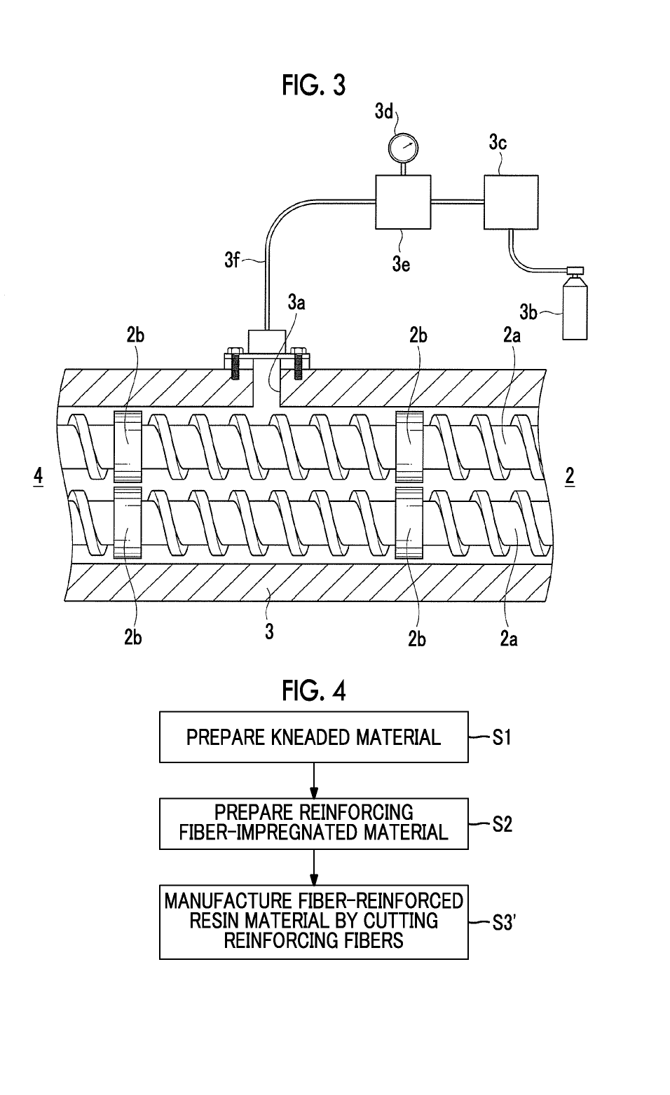

FIG. 1 is a flowchart showing the method of manufacturing a fiber-reinforced resin material according to the first embodiment of the disclosure. FIG. 2 is a diagram schematically showing the device of manufacturing a fiber-reinforced resin material according to the first embodiment of the disclosure. FIG. 3 is an enlarged view schematically showing a sealed space.

First, the first embodiment of the method of manufacturing a fiber-reinforced resin material will be described with reference to the flowchart shown in FIG. 1.

In the method of manufacturing a fiber-reinforced resin material, first, a kneaded material is prepared by melting a thermoplastic resin and kneading the molten thermoplastic resin with reinforcing fibers (first step S1).

Here, examples of the thermoplastic resin include: crystalline plastics which have a high area ratio of a crystalline region in which molecular chains are arranged in order and have a high crystallinity degree, for example, polyethylene (PE), polypropylene (PP), nylon (for example, PA: nylon 6 or nylon 66), polyacetal (POM), or polyethylene terephthalate (PET); and amorphous plastics which has an extremely low crystallinity degree or is not crystalline, for example, polystyrene (PS), polyphenylene sulfide (PPS), polyvinyl chloride (PVC), polymethyl methacrylate (PMMA), an ABS resin, or a thermoplastic epoxy. Among these thermoplastic resins, one kind is used.

On the other hand, examples of the reinforcing fibers to be mixed with the molten thermoplastic resin include: ceramic fibers such as boron, alumina, silicon carbide, silicon nitride, or zirconia; inorganic fibers such as glass fibers or carbon fibers; metal fibers such as copper, steel, aluminum, or stainless steel; and organic fibers such as polyamide or polyester. Among these reinforcing fibers, one kind may be used alone, or a mixed material of two or more kinds may be used.

After the kneaded material is prepared by kneading the molten thermoplastic resin and the reinforcing fibers with each other in the first step, a reinforcing fiber-impregnated material including a supercritical fluid is prepared by accommodating the kneaded material in a sealed space and supplying the supercritical fluid into the sealed space such that the molten thermoplastic resin is impregnated into the reinforcing fibers included in the kneaded material (second step S2).

The supercritical fluid refers to a fluid having diffusibility which is a gas property and meltability which is a liquid property. As the supercritical fluid, nitrogen (critical temperature Tc=−147° C., critical pressure Pc=3.4 MPa) or carbon dioxide (critical temperature Tc=about 31° C., critical pressure Pc=about 7.4 MPa) is used. The supercritical fluid is prepared using a general a supercritical fluid generator and then is supplied into the sealed space.

The sealed space into which the supercritical fluid is supplied is maintained at a high pressure in order to maintain the supercritical state of the supercritical fluid.

After the reinforcing fiber-impregnated material including the supercritical fluid is prepared in the second step, a fiber-reinforced resin material is manufactured by extracting the reinforcing fiber-impregnated material from the sealed space and leaving the reinforcing fiber-impregnated material to stand in a reduced-pressure atmosphere such that the supercritical fluid foams (third step S3).

By extracting the reinforcing fiber-impregnated material including the supercritical fluid from the sealed space and leaving the reinforcing fiber-impregnated material to stand in a reduced-pressure atmosphere (for example, in an atmospheric pressure atmosphere), the supercritical fluid foams, and the reinforcing fibers are disintegrated from a bundle and can be dispersed in the thermoplastic resin.

According to the manufacturing method shown in FIG. 1, the supercritical fluid is supplied to the sealed space in which the kneaded material is accommodated. Further, the reinforcing fiber-impregnated material including the supercritical fluid, which is prepared in the sealed space, is extracted from the sealed space and is left to stand in a reduced-pressure atmosphere. As a result, the thermoplastic resin is impregnated into the bundle of reinforcing fibers, and the reinforcing fibers are dispersed in the thermoplastic resin. Therefore, the area of interfaces between the thermoplastic resin and the reinforcing fibers increases, and a fiber-reinforced resin material having excellent mechanical properties can be manufactured.

Next, the first embodiment of the device of manufacturing a fiber-reinforced resin material will be described with reference to FIG. 2.

Briefly, the device 10 shown in FIG. 2 includes: a melting portion 1 that melts a thermoplastic resin (a pellet P of the thermoplastic resin); a kneading portion 2 that supplies reinforcing fibers F to molten thermoplastic resin R and kneads the reinforcing fibers F and the molten thermoplastic resin R with each other; a supercritical fluid suppling portion having a sealed space 3 in which a supercritical fluid is supplied to a kneaded material including the thermoplastic resin R and the reinforcing fibers F; and a pressure-reduced portion 4 in which a reinforcing fiber-impregnated material including the kneaded material and the supercritical fluid is left to stand in a reduced-pressure atmosphere.

The melting portion 1 is formed of a twin screw extruder including two full flight screws 1a that are rotatably provided (FIG. 2 shows only one of the two full flight screws 1a provided before the page). In the melting portion 1, the pellet P of the thermoplastic resin is supplied to the twin screw extruder, and the molten thermoplastic resin R is supplied to the kneading portion 2 (X1 direction) while being rotated by the full flight screws 1a.

The kneading portion 2 is formed of another twin screw extruder. In the kneading portion 2, the reinforcing fibers F in the form of a bundle T are supplied to the molten thermoplastic resin R which is supplied from the melting portion 1, and a kneaded material including the thermoplastic resin R and the reinforcing fibers F is prepared while being rotated by full flight screws 2a.

A plurality of seal rings 2b are provided at intermediate positions of each of the full flight screws 2a of the twin screw extruder forming the kneading portion 2, and the sealed space 3 is formed by the respective seal rings 2b of the full flight screws 2a. The kneaded material is supplied to the sealed space 3 (X2 direction), and the supercritical fluid is supplied to the kneaded material in the sealed space 3.

As shown in FIG. 3, an injection portion 3a for supplying the supercritical fluid is provided in the sealed space 3 of the twin screw extruder. the supercritical fluid such as carbon dioxide or nitrogen, which is generated by a supercritical fluid generator 3c using gas supplied from a gas tank 3b, is supplied to the sealed space 3 through a supply pipe 3f connected to the injection portion 3a. Optionally, a flowmeter 3d that measures the flow rate of the supercritical fluid, or a flow rate adjustment mechanism 3e that adjusts the flow rate may be provided in the supply pipe 3f.

As a sealing mechanism of the sealed space 3, an appropriate mechanism which stops the flows of the materials in the twin screw extruder to increase the internal pressure (material filling rate) of the sealed space is applied, and examples thereof include the seal ring 2b, a reverse kneading disk screw, a reverse full flight screw, and a gate valve.

The pressure-reduced portion 4 is provided downstream of the sealed space 3, and the reinforcing fiber-impregnated material including the kneaded material and the supercritical fluid is supplied to the pressure-reduced portion 4 (X3 direction). In the pressure-reduced portion 4, the reinforcing fiber-impregnated material is left to stand in a reduced-pressure atmosphere such that the supercritical fluid foams. As a result, the fiber-reinforced resin material is manufactured and transported from the device 10 (X4 direction).

The pressure-reduced portion 4 is a region which is provided outside the high-pressure sealed space 3 and where the high-pressure state is naturally converted into a reduced-pressure state.

According to the device 10, intermediate materials were caused to pass through the respective components in order. As a result, the steps from the thermoplastic resin melting step to the fiber-reinforced resin material manufacturing step can be performed continuously and efficiently, and a fiber-reinforced resin material having excellent mechanical properties can be manufactured.

(Second Embodiment of Method and Device of Manufacturing Fiber-Reinforced Resin Material)

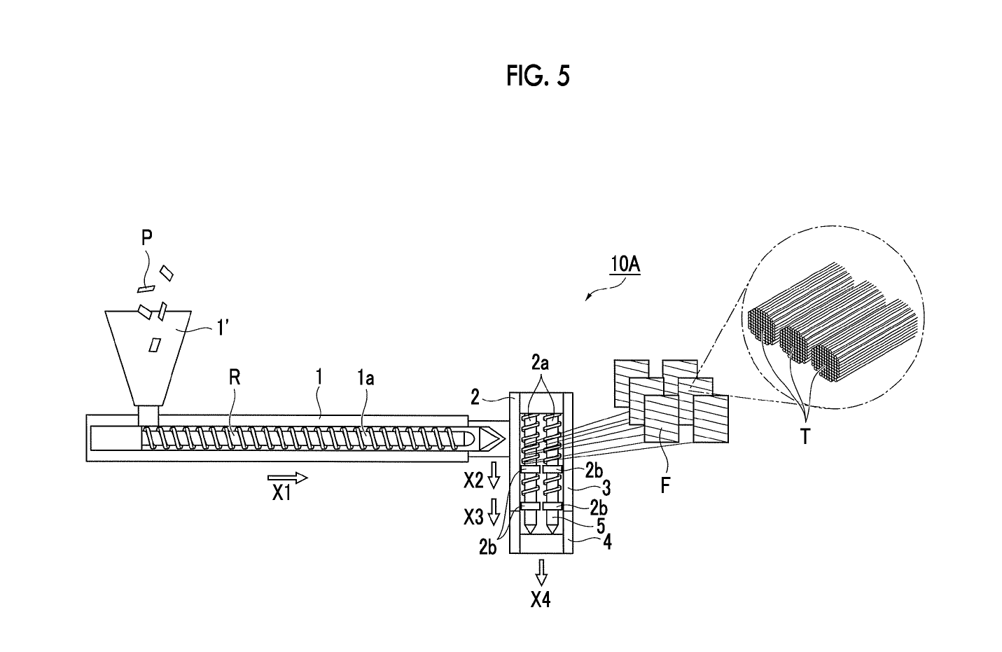

FIG. 4 is a flowchart showing the method of manufacturing a fiber-reinforced resin material according to the second embodiment of the disclosure. FIG. 5 is a diagram schematically showing the device of manufacturing a fiber-reinforced resin material according to the second embodiment of the disclosure.

The second embodiment of the method is different from the first embodiment of the method, in that a fiber-reinforced resin material is manufactured by cutting the reinforcing fibers in a third step S3′.

That is, in the third step S3′, the fiber-reinforced resin material is manufactured by cutting the reinforcing fibers by mechanical cutting or the like while the supercritical fluid foams.

More specifically, by cutting the reinforcing fibers using a cutter such as a kneading screw having a high shearing force, the shearing force is applied in a state where the thermoplastic resin is sufficiently impregnated into the reinforcing fibers. The shearing force transmitted from the thermoplastic resin to the reinforcing fibers is as uniform as possible in the entire region, and a variation in the fiber diameter of the reinforcing fibers can be reduced or eliminated.

A device 10A of manufacturing a fiber-reinforced resin material shown in FIG. 5 is different from the device 10, in that a cutter 5 such as a kneading screw is provided in the pressure-reduced portion 4.

Examples of a method of cutting the reinforcing fibers include a mechanical cutting method using a kneading screw, a cutting method of adding an acid to the reinforcing fibers to damage the reinforcing fibers, and a cutting method of transmitting a rotating force of a screw to the reinforcing fibers through the resin.

According to the device 10A, the reinforcing fibers whose fiber diameter is maintained are uniformly dispersed in the thermoplastic resin, and a fiber-reinforced resin material having excellent mechanical properties can be manufactured continuously and efficiently.

(Experiment for Verifying Mechanical Properties of Fiber-Reinforced Resin Material, and Result thereof)

The present inventors prepared fiber-reinforced resin materials according to Example and Comparative Example and performed an experiment for verifying mechanical properties thereof.

In Example and Comparative Example, the fiber-reinforced resin material was prepared using a thermoplastic resin (PA6, AMILAN CM1017, manufactured by Toray Industries Inc.) and carbon fibers (PAN-based, T700 12K, manufactured by Toray Industries Inc.) having a content of 30 vol %. 60 wt % (with respect to the weight of fiber-reinforced resin material) of PA6 as the thermoplastic resin was supplied to the melting portion of the twin screw extruder, and the temperature of the melting portion was set such that the resin temperature of PA6 supplied to the kneading portion was 260° C. Next, 40 wt % (with respect to the weight of fiber-reinforced resin material) of the carbon fibers were supplied to an open vent port of the kneading portion, and a kneaded material including PA6 and the carbon fibers was prepared. The screw rotating speed of the twin screw extruder, which formed not only the kneading portion but also the sealed space and the pressure-reduced portion, was 100 rpm. The temperature of each component of the twin screw extruder was set such that the temperature of the fiber-reinforced resin material in the kneading portion, the sealed space, and the pressure-reduced portion was 260° C. Carbon dioxide in the supercritical state was supplied from the supercritical fluid injection portion to the sealed space in an addition amount of 5 wt % and was kneaded with the fiber-reinforced resin material. The fiber-reinforced resin material extruded from the device through the pressure-reduced portion was supplied onto a flat tool for press forming having a size of 400 mm×400 mm and was press-formed into a flat plate. In Example, the supercritical fluid was supplied to the kneaded material during the manufacturing process. However, in Comparative Example, the supercritical fluid was not supplied to the kneaded material during the manufacturing process.

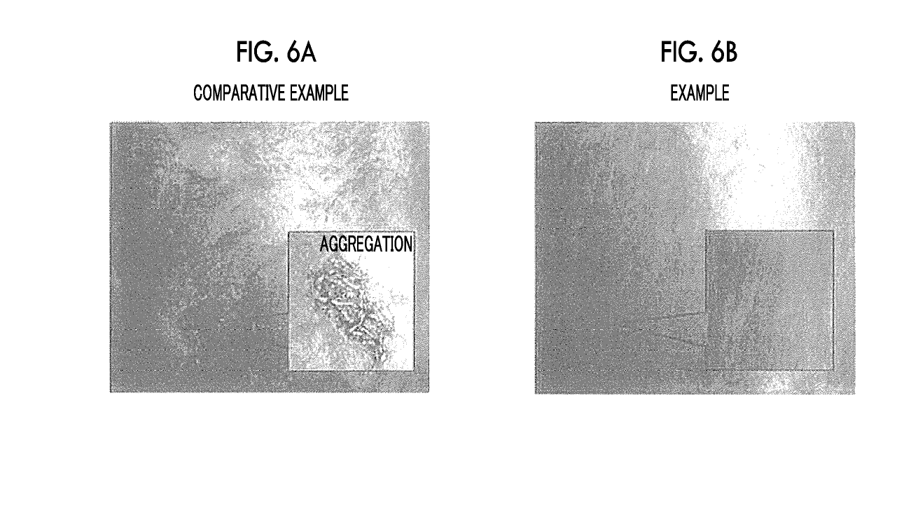

FIGS. 6A and 6B show images showing the external appearances of Comparative Example and Example, respectively, and Table 1 below shows the verification results regarding bendability as a mechanical property. A bending test was performed according to JIS-K7017 by cutting a test piece from the flat plate.

TABLE 1

| | Bending | Bending Elastic |
|---|---|---|
| | Strength | Modulus |
| | (MPa) | (GPa) |
| Comparative Example | 273 | 16 |
| Example | 295 | 17 |

It was found from FIGS. 6A and 6B that, in Example, the dispersion of the carbon fibers was clearly improved as compared to Comparative Example.

It was verified from Table 1 that the bending strength of Example was improved by about 8% as compared to Comparative Example.

Hereinabove, the embodiments of the disclosure have been described with reference to the drawings, but specific configurations thereof are not particularly limited to the above-described embodiments. Within a range not departing from the scope of the disclosure, design changes and the like can be made and are embraced in the disclosure.

What is claimed is:

1. A method of manufacturing a fiber-reinforced resin material, the method comprising:
preparing a kneaded material by melting a thermoplastic resin and kneading the molten thermoplastic resin with reinforcing fibers;
preparing a reinforcing fiber-impregnated material including a supercritical fluid by accommodating the kneaded material in a sealed space and supplying the supercritical fluid into the sealed space such that the molten thermoplastic resin is impregnated into the reinforcing fibers included in the kneaded material; and
manufacturing the fiber-reinforced resin material by extracting the reinforcing fiber-impregnated material from the sealed space and leaving the reinforcing fiber-impregnated material to stand in a reduced-pressure atmosphere such that the supercritical fluid foams.

2. The method according to claim 1, wherein
when the fiber-reinforced resin material is manufactured, the fiber-reinforced resin material is manufactured by cutting the reinforcing fibers while the supercritical fluid foams.

3. A device of manufacturing a fiber-reinforced resin material, the device comprising:
a melting portion configured to melt a thermoplastic resin;
a kneading portion configured to supply reinforcing fibers to molten thermoplastic resin and to knead the reinforcing fibers and the molten thermoplastic resin with each other;
a supercritical fluid supplying portion having a sealed space where a supercritical fluid is supplied to a kneaded material including the thermoplastic resin and the reinforcing fibers; and
a pressure-reduced portion configured to leave a reinforcing fiber-impregnated material including the kneaded material and the supercritical fluid to stand in a reduced-pressure atmosphere.

4. The device according to claim 3, wherein
the pressure-reduced portion includes a cutter.
